(19) United States
(12) Patent Application Publication
(10) Pub. No.: US 2002/0130051 A1
(43) Pub. Date: Sep. 19, 2002

(54) Bipolar electrodes with semiconductor layers providing integrated procedures for the electrolysis of water

(75) Inventors: Helmar Haug, Bisingen (DE); Rene Nikolai Janicke, Albstract (DE)

Correspondence Address: Carl E. Moore, Jr., MARSHALL, GERSTEIN & BORUN, 6300 Sears Tower, 233 South Wacker Drive, Chicago, IL, 60606-6402, US

(73) Assignee: PROVERA GmbH

(21) Appl. No.: 10/083,096

(22) Filed: Feb. 26, 2002

Related U.S. Application Data
(62) Division of application No. 09/783,228, filed on Feb. 14, 2001.

(30) Foreign Application Priority Data
Feb. 18, 2000 (DE) DE 100 07 480.4

(51) Int. Cl. C02F 1/461

(52) U.S. Cl. 205/742; 204/293; 204/290.01; 204/290.12; 205/759

(57) ABSTRACT

The invention concerns a bipolar electrode with a semiconductor coating and a cathode, as well as a procedure for the electrolytic dissociation of water, especially for the recovery of hydrogen. The body material of the cathode and/or the anode in this procedure is preferably comprised of titanium or platinum coated titanium, whereby, on the anode an additional semiconductor coating is applied, said coating being preferentially titanium dioxide (TiO₂), which is dosed with iron (Fe). The advantage of the bipolar electrode is that an increased volume of hydrogen per time unit can be recovered and further, with these bipolar electrodes a simple procedure at ambient surroundings and conditions is achieved without expensive equipment for hydrogen production. In addition the anode of the invented bipolar electrodes can also be radiated with UV-radiation for the purpose of an increase in efficiency.

The present invention concerns a bipolar electrode with semiconductor coating, comprising an anode and a cathode, and a procedure for electrolytic water dissociation, in particular, for the yield of hydrogen.

In regard to “electrolysis”, one understands generally, a chemical processing and a chemical change of a material, which take place upon the conduction of an electrical current through an electrolyte. “Electrolytes” are to be understood as materials, of which the water solutions, as well as the melts are electrical conductors; examples include acids, bases and salts. Electrolysis is somewhat the reverse of a battery, wherein an electrical voltage is engendered, between electrodes in an electrolyte.

If one immerses into an electrolytic solution, two electrodes (anode and cathode) connected with a direct current voltage source, then an electric current will flow, because of the chemical electromotive force. Further, in the said electrolytic solution, a charge in the form of charged ions is transported. The positive charged ions (cations) take electrons away from the cathode, while the negative charged ions (anions) release their electrons to the anode. By means of this neutralization, the ions dissolved in the electrolytic solution change their chemical characteristics, whereby these neutralized ions are separate out at the electrodes in solid or gaseous form (for instance, hydrogen, oxygen).

From the state of the technology, already multitudinous procedures are known for the electrolysis of chemical substances, such as, for example chlor-alkali electrolysis, alkali metal chloride electrolysis and the alkali halogen electrolysis. Further, it is also a known practice, to coat the electrodes proposed for such electrolysis, for instance with cobalt and tungsten, whereby also semiconductor material is employed as a coating material.

DE 37 372 35 A1 discloses a procedure for the manufacture of an anode for chlor-alkali electrolysis, wherein titanium is used as a carrier substrate and salts of platinum and salts of metals, which contain no platinum, are used for a coating material.

EP 21 87 06 B1 makes known a cathode for electrolysis for alkali halogen solutions, wherein as a substrate, a metal is used out of a group which contains iron, chromium, stainless steel, cobalt, nickel, copper and silver. Alloys of said metals can be also be used. As a ceramic coating material, a metal oxide is employed from a group containing ruthenium, iridium, platinum, palladium rhodium, titanium, tantalum, niobium, zirconium, hafnium, tin, manganese and yttrium. In this case, the coating is dosed with oxides of cadmium, thallium, arsenic, bismuth, tin and antimony.

The common and principal goal of the electrodes in accord with the above state of the technology, is: by means of the coating of the electrodes, to increase the duration of operational time of the electrodes, especially during electrolysis and also to reduce the formation of undesirable gases such as hydrogen, and oxygen because of safety and economic reasons. An increase of the gas yield is thus not looked forward to, but rather something to be avoided.

Advantageously, the above stated procedures and coated electrodes were not employed for the dissociation of water into hydrogen and oxygen, however, procedures for the dissociation of water with coated electrodes are in public knowledge, wherein these electrodes are not coated with semiconductors, but, for instance, with metals, such as zinc, or aluminum, or alloys thereof. Such procedures are found in DE 38 373 52.

This procedure with coated electrodes for water dissociation into hydrogen and oxygen operates economically only in connection with extremely high temperatures (200-300° C.) and at substantial pressures, such as (30 to 100 bar).

In the case of hydrogen production by means of water dissociation by means of solar energy, the high energy usage in the production of the photovoltaic silicon is very disadvantageous, since silicon must be produced by a chemical reduction.

Thus, it is the purpose of the present invention to make available a bipolar electrode (anode and cathode) in accord with the above mentioned state of the technology, which contributes to an increase of the yield of hydrogen (measured in volumes of hydrogen per unit of time) by the dissociation of water, and this increased hydrogen yield is to be achieved without expensive equipment at the ambient conditions of pressure and temperature.

In accord with the invention, these named goals are achieved, in that the bipolar electrode consists of a cathode, which is distanced from an anode, and both the cathode and the anode are made from a body material from at least one element of the main groups III, IV and/or the transition metals 4 to 7 of the periodic table. Onto the body material of the anode a semiconductor coating is applied, which semiconductor coating is from at least one element of the transition metals 4 to 7 of said periodic table.

It would be preferable, if both the cathode and the anode are of one body material, particularly titanium, and upon this body material of the anode, a semiconductor coating is applied, which semiconductor material coating contains a titanium oxide, namely TiₓO_{y}, wherein x and y are positive integers.

In such an arrangement it is advantageously provided, that if the body material titanium, of at least one of the poles, either the anode or the cathode, is coated with an element of the transition metal group 1, 2 and/or 8 of the periodic table, preferably with a platinum coating. This platinum coating is advantageously applied in a very thin layer, perhaps in the a neighborhood of a few μm, typically 1 μm for the anode and 1.5 μm for the cathode. Preferably the coating is applied onto the titanium substrate by a vacuum vaporization process.

The n-semiconductor coating of, for instance, titanium dioxide on titanium, however, presents a relatively high resistance for the electrical current circuit.

For this reason, it has been provided in a bipolar electrode arrangement of the present invention, that the semiconductor coating TiₓO_{y} is treated by dosing with one or more of the elements of the 1, 2 or 8 groups of the periodic table.

Advantageously, the dosing is with iron (Fe) in a relative high concentration, typically 25 wt %. Naturally, other concentrations can be used, up to 33 wt %.

Other materials which can be used for said dosage-elements are, for example, cobalt, ruthenium, nickel, rhodium, palladium, osmium, iridium, copper, silver, gold, zinc, cadmium, and mercury and their compounds. By means of these dosages, the electrical resistance of the semiconductor is reduced, especially when a very high concentration of the dosing agent is employed.

Preference is given to titanium dioxide (TiO₂) when the coating applied to the body material of the anode is defined as TiₓO_{y}.

Titanium dioxide belongs to the n-semiconductors and absorbs mainly in the UV spectrum and is also employed in the photo-catalytic treatment of waste waters. Titanium dioxide scarcely absorbs in the visible spectrum and cannot be used for direct sun energy procedures. Titanium oxide is, however an economical and non-poisonous material.

In this field, titanium dioxide can be applied on a titanium carrier or by means of a anatase-suspension (anatase=mineral TiO₂) as a titanium dioxide coating on titanium, in order, thereby, to achieve an increase of the titanium dioxide surface and thereby to reach a stronger discharge of the ions. The titanium substrate is, in this matter, preferred to be immersed in an aqueous suspension of titanium dioxide-anatase with about 5 g/100 ml H₂O, and finally dried at ca. 80° C. This procedure is then repeated a plurality of times. Thereby, the power consumption of the bipolar electrodes would be diminished by about 20 to 30%.

The titanium dioxide, in a development of the invention, can also be precipitated from titanium tetrachloride. The result of this, would be an increase in the degree of particulate size and a concomitant increase in the surface of the applied titanium dioxide. By this means again, the electrical power consumption would be decreased by about 35%.

For the generation of a particularly large titanium dioxide surface, the known Sol-Gel-Transformation has shown itself as well adapted. In this process, titanium dioxide is mixed into the start components for condensation polymerization and the polymerization is broken off in a colloidal intermediate state.

In this manner, one obtains a stable sol-gel plastic coating that contains embedded titanium dioxide. Particularly advantageous are following anode plates with a thickness of a coating of about 1 μm. The coating is respectively Ti/TiO₂, Ti/Pt/TiO₂, Ti/TiO₂(Fe), Ti/Pt/TiO₂(Fe), with a 23 wt % (Fe) iron dosing. In this case, preferably for the cathode, titanium or Ti/Pt is provided, wherein here, too, the platinum is applied with a somewhat thicker layer of about 1.5 μm onto the body material titanium.

Instead of titanium as a substrate, platinumized titanium can be used, or a platinum coated titanium substrate, which subsequently is subjected to a sol-gel-coating. The cell resistance can be cut here about one-third. Titanium, in relation to platinumized titanium, even before the coating with the sol-gel layer, obtains an oxide layer of poor conductivity. This is, however, of advantage for the anode.

The conditions for the cathode are quite the reverse. In comparison of the platinum titanium cathode with a pure titanium cathode, the hydrogen generation of the platinum titanium increases by about one-third, and at the same time a lesser power consumption is obtained. A radiation of the semiconductor coating on the anode leads to an improvement of the hydrogen generation, which, especially in the case of the sol-gel coated anode (not dosed with iron) is an improvement.

The following volumes of hydrogen can be obtained by means of the different electrode pairs without dosing:

| | | H₂ without UV | H₂ with UV |
|---|---|---|---|
| Cathode | Anode | radiation | radiation |
| TI/Pt | TI/Pt | 0.9 ml (5 min) | 1.2 ml (5 min) |
| TI/Pt | Ti/TiO₂-sol/gel | 0.4 ml (5 min) | 2.1 ml (5 min) |

The electrodes dosed with iron and coated by the sol-gel coating method, show in this an essentially better yield of hydrogen, for instance, in the case of a cathode of Ti/Pt and an anode of Ti/TiO₂ dosed with iron, thus Ti/TiO₂(Fe). With UV radiation, as much as ten times the quantity of hydrogen may be collected as is possible without iron dosing and the cell resistance lowered by one-fifth. The reinforcement of the (+)-vacancies in the valance band and the conductive band electrons are the reason for this advantage.

Reaction Mechanics:

Minus Pole:

2H₂O+2e⁻→H₂+2OH⁻

Plus Pole:

$$2 {OH}^{-} \to {H}_{2} O + \frac{1}{2} {O}_{2} + 2 {e}^{-} \qquad ( 2 )$$

The exact mechanism for the anodic oxidation is:

(Where (s)=surface and

pH>12)

2OH⁻(s)→2OH(s)+2e⁻ (3)

2OH⁻(s)→H₂O₂(s) (4)

H₂O₂(s)→H₂O₂(aq) (5)

$${H}_{2} {O}_{2} ( aq ) \to {H}_{2} O + \frac{1}{2} {O}_{2} \qquad ( 6 )$$

The oxidation of the OH⁻ ions is carried out by (+) electron vacancies of titanium dioxide:

OH⁻(s)+h⁺_{VB}→OH⁻(s) (7)

Based on the reaction (7), the oxidation of OH⁻ ions can be reinforced by dosage with iron.

Further, by means of an increase in the pH value, that is, from 13 to 14 under UV radiation, the hydrogen achieved by dissociation can be increased by about one-third, whereby the applied voltage may be reduced by one-half.

By means of a diminution of polarization effects—possibly a by current density mainly of passage polarization and inhibitor action—a higher electrolyte concentration activates a better electrolysis performance and sets aside the cell resistance.

In accord with equation (7), a more dense saturation of the surface with OH⁻ ions has an advantageous effect, whereby, however, the UV-radiation grants only a very small increase of hydrogen generation.

As these operations are carried out, a greater voltage is created, whereby the flow of electrons into the inner of the nucleus is enhanced and simultaneously, the electron yield from the conducting band to the electrolytes, as well as the therewith connected, positive space-charge is weakened. The recombination of the light induced (+)-electron vacancies and conductive band electrons increases.

Where:

U_{Z}=dissociation voltage

E_{A}=normal potential at anode

E_{X}=normal potential at cathode

n_{A}=excess potential at anode

n_{K}=excess potential at cathode

R=ohmic resistance

then:

U_{Z}=E_{A}−E_{K}+n_{A}−n_{K}+I [symbol] R

The 1 μm thick semiconductor coating of TiO₂(Fe) with iron dosage, applied in accord with the sol-gel procedure, activates a fourfold hydrogen yield at about half the current.

The platinumized titanium anode and an applied sol-gel-titanium oxide layer with iron dosage (1 μm) in combination with a non-coated titanium cathode, brings about the best yield of hydrogen, wherein, simultaneously, oxygen is evolved with the hydrogen, although only in half the volume.

By means of the iron dosaging, the resistance of the semiconductor drops about one-fifth, where platinum is the basic coating, then this drop is one-third. On this account, the semiconductor coating leads to an essentially optimization in relation to a pure platinum coating, since OH⁻, H₂O₂, and O⁻ influence the activation of the electrodes.

As compared to the state of the technology, there is an H₂O₂ bonding to titanium dioxide, as well as an oxidation of H₂O₂ and of OH⁻ by (+) electron holes in the iron dosed titanium dioxide.

H₂O₂(s)+2h⁺_{VB}+2OH⁻→O₂+2H₂O

OH⁻(s)+h⁺_{VB}→2OH⁻ (s)

The following results were obtained upon the use of the optimal electrode combinations:

| | |
|---|---|
| Cathode | Ti 1 mm |
| Anode | Ti/Pt 1.5 μm |
| Coating on anode | TiO₂(Fe)(1 μm sol-gel) 23% iron dosage |
| Electrolyte | NaOH, pH 14 |
| Electrolyte temperature | 15° C. |
| Voltage | 3.1 V |
| Current density | 1 A/128 cm² |
| H₂ generation in five minutes | 34 ml |
| O₂ generation in five minutes | 17.2 ml |

| Efficiency: | Electrolysis action: |
|---|---|
| W = 3.1 V × 1A × 300 s ≈ 900 J | 300 s · 1A = 300 C |
| 22.4 ml H₂ = 286.0 J | 96.5 C = 11.2 ml |
| 35.0 ml H₂ = 446.8 J | 300 C = 34.8 ml |
| η = 49.6% ≈ 50% | $\frac{34.0 ml}{34.8 ml} = 99 \%$ |

Upon a temperature rise of the electrolyte solution, for instance, up to the ambient room temperature, the degree of efficiency can, once again, be substantially increased.

The stability of the degree of efficiency of the invented electrode coating for extended times is only slightly reduced by a peroxide treatment of the titanium dioxide coating. However, during the drying period of the electrode, the peroxide decomposes and the original efficiency returns to its former higher value. In view of this situation, it is evident that for a additional increase in efficiency, a toggle operation is foreseen, whereby a first electrode pair finds itself in the electrolyte, and that, or an exchange pair, will be located outside of the electrolyte for drying.

In the following, the invention is explained and described in greater detail. From reference to the drawings and the description with the aid of said drawings, further invented features and advantages of the invention will be brought forward. There is shown in:

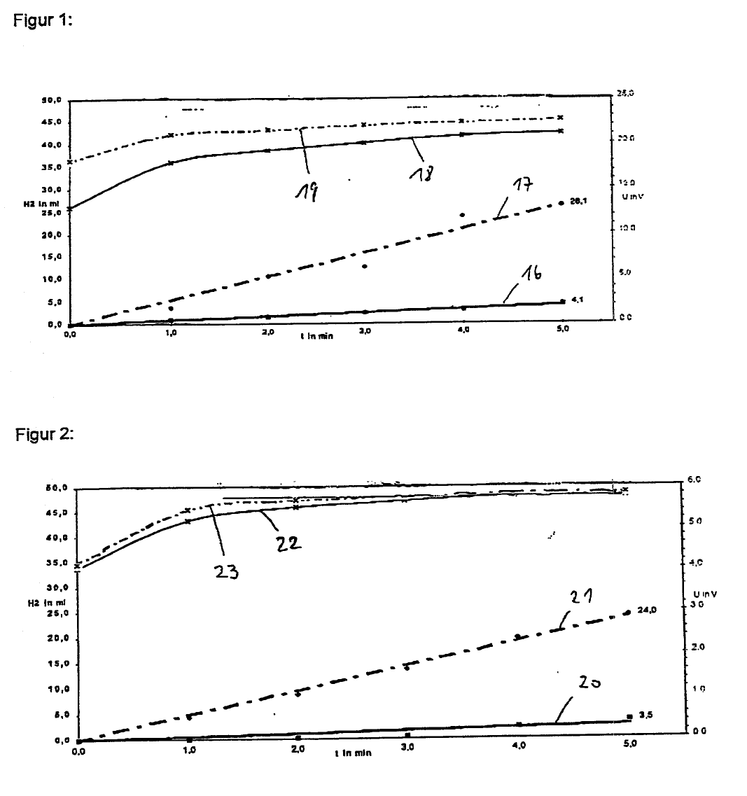

FIG. 1 a diagram with curves of the hydrogen yield and the cell voltage, both in reference to time, dependent upon the parameters of the UV-radiation with the anode material Ti/TiO₂(Fe);

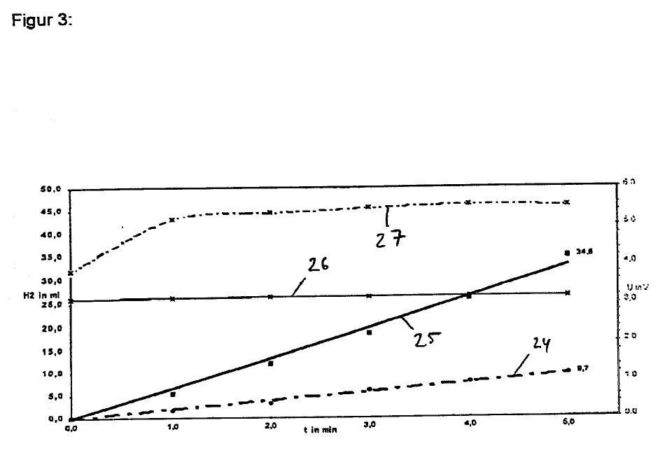

FIG. 2 a diagram with curves of the hydrogen yield and the cell voltage, both in reference to time, dependent upon the parameters of the UV-radiation with the anode material Ti/Pt/TiO₂(Fe);

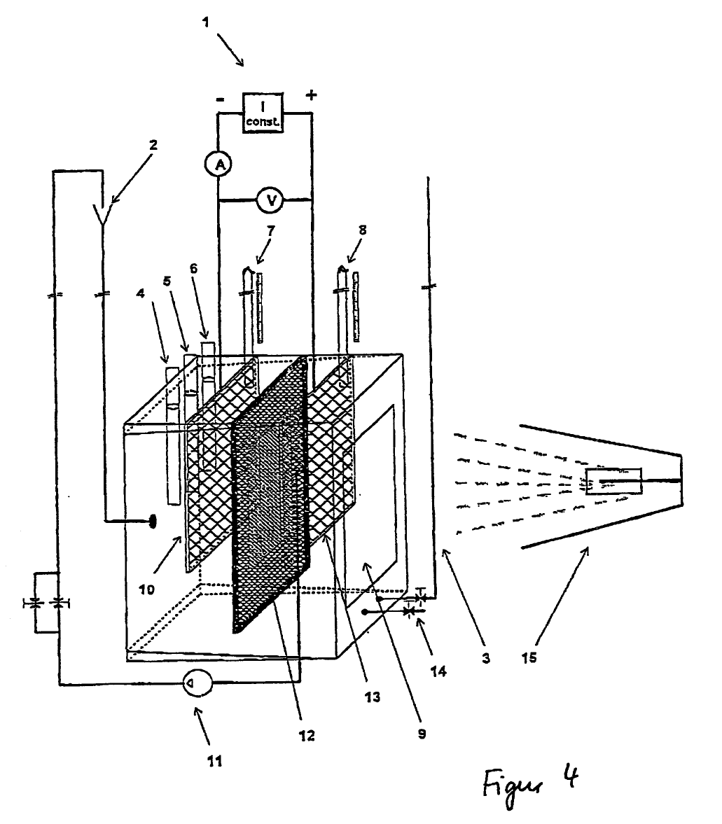

FIG. 3 a diagram with curves of the hydrogen yield and the cell voltage, in reference to time, respectively in comparison to the anode materials Ti/Pt and Ti/Pt/TiO₂(Fe); and

FIG. 4 the construction of an apparatus for the execution of the process in accord with the invention for electrolytic water dissociation by means of the bipolar electrode in accord with the invention.

In FIG. 1 a diagram is seen, in which the hydrogen yield (16, 17) and the cell voltage U (18, 19) are respectively drawn in reference to time in dependency of the UV radiation. These curves are based on anode material Ti/TiO₂(Fe) and cathode material Ti/Pt. It can be plainly seen, that with increasing radiant intensity of an emitting UV source in the UV-spectrum of 250 nm to 380 nm wavelength, the yield of hydrogen (17) markedly increases, and at the same time the cell voltage (19) principally increases but little, so that the radiation of the bipolar electrode with the previously mentioned electrode materials is a well suited means for the optimizing of the process for the recovery of hydrogen by the dissociation of water.

In the diagram of FIG. 2, is shown how the hydrogen yield (20, 21) and the cell voltage U (22, 23) can be graphed against the time, in dependency of the UV-radiation. In this case, operation was with anode material Ti/Pt/TiO₂(Fe) and the cathode material being Ti/Pt. The body material of the anode was Titanium, coated with Pt. Also in this case, one can easily infer, that with the increasing radiation intensity of an emitting UV-source in the UV-spectrum of 250 nm to 380 nm wavelength, the yield of hydrogen (21) substantially increases and simultaneously, the cell voltage U (23) slowly increases, so that the radiation of the bipolar electrode with the previously mentioned electrode material is a advantageous medium for the optimization of the procedure for the recovery of hydrogen by means of water dissociation. The effect achieved in accord with FIG. 1 are still clearly improved.

The diagram of FIG. 3 plots the hydrogen yield and the cell voltage U against time in comparison to the anode material Ti/Pt and Ti/Pt/TiO₂(Fe). Here is shown, that the volumes of the hydrogen yield (24, 25) in the case of an anode of Ti/Pt/TiO₂(Fe), relative to an anode of Ti/Pt (24) is strongly increased along with a simultaneous diminution of the cell voltage (26) when compared to cell voltage (27) of the anode of Ti/Pt (24), wherein this cell voltage (26) of the anode of Ti/Pt/TiO₂(Fe) (25) at the same time, runs practically constant over the time span.

FIG. 4 shows the principal construction of an apparatus for the carrying out of the invented procedure for the electrolytic dissociation of water by means of the invented bipolar electrode 10, 13.

The anode 13 and the cathode 10 are designed to be somewhat plate shaped and are placed parallel to one another, to form the bipolar electrode of the invention. The cathode 10 is connected by electrical lines through an ammeter A with the minus pole of a constant current source 1.

On the other hand, the anode 13 is electrically connected with the plus pole of the said constant current source 1. Between the connectors of the two electrodes 10, 13 is located a voltmeter V. The constant current source 1 possesses, at a current of 1A, a maximum voltage of Uₘₐₓ=32V.

In the intervening space between anode 13 and the cathode 12, is located an ion-exchange membrane 12, which at least possesses a surface equal to that of each electrode 10, 13, so that said intervening space is completely covered by this ion exchange membrane 12. However, there is no contact to said electrodes 10, 13. The ion exchange membrane 12 is made in this case by a perfluoridized polymer with sulfonic acid groups.

This arrangement finds itself within a receiving space, in which the electrolyte solution, in this case NaOH at pH 13 or 14, is circulated around in the circulation apparatus 11 by a pump. Within the circulation apparatus 11, is found a pressure equalizing system 2. By means of a valve 14, the said receiving space can be completely emptied.

The lines of the circulation apparatus 11 are found in the area between the poles (10, 13) of the electrodes in the neighborhood of the ion exchange membrane 12 on the side of the anode.

By means of a level indicator 3, a pH-electrode 4, a temperature sensor 5 and a heating element 6, the corresponding parameters can be monitored and controlled.

The hydrogen and oxygen generated at the electrodes can be removed by the lines (7, 8) and conducted to a (not shown) receiving means and there stored.

Outside of the receiving space of the electrolyte liquid, opposite the anode 13 is provided a UV-radiation unit 15, which emits UV-radiation onto the anode 13 through a quartz glass 9, which quartz glass 9 is transparent to UV radiation and is sealingly affixed in the walls of the receiving room. By this means, the produced hydrogen quantity can be substantially increased.

### Reference Number List

1 Constant current source

2 Pressure equalizer

3 Level indicator

4 pH electrode

5 temperature sensor

6 Immersion heating element

7 Hydrogen tubing line

8 Oxygen tubing line

9 Quartz glass

10 Cathode

11 Circulation apparatus

12 Ion exchange membrane

13 Anode

14 In-out valve of hydrolysis tank

15 UV radiation apparatus

16 Hydrogen volume per time unit with Ti/TiO₂(Fe) as anode, not radiated

17 Hydrogen volume per time unit with Ti/TiO₂(Fe) as anode, UV-radiated

18 Cell voltage per time unit with Ti/TiO₂(Fe) as anode, not radiated

19 Cell voltage per time unit with Ti/TiO₂(Fe) as anode, UV-radiated

20 Hydrogen volume per time unit with Ti/Pt/TiO₂(Fe) as anode, not radiated

21 Hydrogen volume per time unit with Ti/Pt/TiO₂(Fe) as anode, UV-radiated

22 Cell voltage per time unit with Ti/Pt/TiO₂(Fe) as anode, not radiated

23 Cell voltage per time unit with Ti/Pt/TiO₂(Fe) as anode, UV-radiated

24 Hydrogen volume per time unit with Ti/Pt as anode

25 Hydrogen volume per time unit with as anode Ti/Pt/TiO₂(Fe) as anode

26 Cell voltage per time unit with Ti/Pt as anode

27 Cell voltage per time unit with Ti/Pt/TiO₂(Fe) as anode

What is claimed is:

1. A bipolar electrode with a semiconductor coating, comprising an anode and a cathode, said anode and cathode displaced apart from one another, said cathode and anode comprising a body material selected from the group consisting of elements of the main groups III, IV and the groups 4-7 of the periodic system or mixtures thereof, and a semiconductor coating on the outer surface of said anode body, said semiconductor coating selected from the group consisting of at least one element of groups 4-7 of the periodic system.

2. A bipolar electrode with a semiconductor coating in accordance with claim 1 wherein in that the body material of the cathode and/or the anode consists of titanium alone or in combination with another group III, IV or groups 4-7 element.

3. A bipolar electrode with a semiconductor coating in accord with claim 1 wherein the semiconductor coating applied on the body material of the anode comprises a titanium oxide (TiₓO_{y}), wherein x and y are positive integers.

4. A bipolar electrode with a semiconductor coating in accordance with claim 3 wherein said semiconductor coating is TiO₂.

5. A bipolar electrode with a semiconductor coating in accordance with claim 1 wherein the body material of at least one of the two electrodes is provided with a coating of at least one element selected from the group consisting of subordinate groups 1, 2 and 8 of the periodic system, or mixtures thereof.

6. A bipolar electrode with a semiconductor coating in accordance with claim 5 wherein said coating comprises platinum.

7. A bipolar electrode with a semiconductor coating in accordance with claim 5 wherein the thickness coating on the anode is between 1 and 2 μm.

8. A bipolar electrode with a semiconductor coating in accordance with claim 1 wherein the semiconductor coating applied to the body material of the anode is dosed with one or more of the elements of the first, second, and/or eighth subordinate groups of the periodic system.

9. A bipolar electrode with a semiconductor coating in accordance with claim 8 wherein iron (Fe) is employed as an element for dosing of the semiconductor.

10. A bipolar electrode with a semiconductor coating in accordance with claim 9 wherein the concentration of iron (Fe) in the semiconductor coating is in the range of 1 wt % to 33 wt %.

11. A bipolar electrode with a semiconductor coating in accordance with claim 9 wherein the concentration of iron (Fe) in the semiconductor coating is approximately 23 wt %.

12. A bipolar electrode with a semiconductor coating in accordance with claim 4 wherein the titanium oxide coating is applied by means of a sol-gel procedure.

13. A bipolar electrode with a semiconductor coating in accordance with claim 9 wherein the dosing of the titanium dioxide coating with iron (Fe) is carried out by means of a sol-gel procedure.

14. A bipolar electrode with a semiconductor coating in accordance with claim 13 wherein the application of the titanium dioxide coating and the dosing with iron (Fe) is done substantially simultaneously.

15. A procedure for the electrolytic dissociation of water employing a bipolar electrode in accordance with claim 1, comprising the following process steps:
a.) preparing a bipolar electrode in accordance with claim 1;
b) inserting the bipolar electrode into an appropriate electrolyte within a container;
(c) adjusting the pH value of the electrolyte to a pH of about 13-14;
(d) applying a direct current voltage to the bipolar electrodes;
(e) continuously circulating the electrolyte liquid by means of a circulation apparatus; and
(f) discharging the gases evolved at the electrodes by means of a pair of gas lines.

16. A procedure in accordance with claim 15 wherein the temperature of the electrolysis is regulated at ca. 22° C.

17. A procedure in accordance with claim 15 further containing the step of continuously radiating the anode with UV-radiation in the range of ca. 250 to 380 nm.

18. A procedure in accordance with claim 17 wherein the source of the UV-radiation lies outside of the container for the electrolyte liquid.
